(19) United States
(12) Patent Application Publication
(10) Pub. No.: US 2011/0300334 A1
(43) Pub. Date: Dec. 8, 2011

(54) FIBROUS STRUCTURAL ARTICLE AND MANUFACTURING METHOD THEREOF

(75) Inventors: Nobukazu UENO, Seki-shi (JP); Yasuhiro BEPPU, Inuyama-shi (JP); Akira TSUBOUCHI, Kitanagoya-shi (JP)

(73) Assignee: TOYOTA BOSHOKU KABUSHIKI KAISHA, Aichi-ken (JP)

(21) Appl. No.: 13/087,661

(22) Filed: Apr. 15, 2011

(30) Foreign Application Priority Data
Jun. 8, 2010 (JP) 2010-131513

(51) Int. Cl. B32B 5/02; B29C 67/00; B32B 3/00

(52) U.S. Cl. 428/141; 428/221; 264/123

(57) ABSTRACT

The present fibrous structural article is a material in a plate-like shape and having multiple fibers adhered to one another, and fibers are oriented from one surface side toward the other surface side of the fibrous structural article, and the fibers are arranged in an annual ring centering on a virtual axis. The present production method of a fibrous structural article comprises a fiber supplying process for blowing and supplying first short fibers and second short fibers, into a forming mold in a hollow box shape and having a first bottom wall, sidewalls and second bottom wall, from a fiber supplying port formed through the first bottom wall, and a melting process for melting at least part of the second short fibers.

### INCORPORATION BY REFERENCE

The present application claims priority under 35 U.S.C. §119 of Japanese Patent Application No. 2010-131513, filed on Jun. 8, 2010, the disclosure of which is expressly incorporated by reference herein in its entirety.

### BACKGROUND OF THE INVENTION

1. Field of the Invention

The present invention relates to a fibrous structural article and a production method thereof. More specifically, the present invention relates to a fibrous structural article that includes depositedly stacked fibers which are oriented from one surface side toward the other surface side of the fibrous structural article and are arranged in an annual ring centering on a virtual axis, such that the fibrous structural article is rarely stretched and broken even upon application of a pulling force thereto in its radial direction to thereby facilitate its handling, and such that a fiber aggregate comprising the depositedly stacked fibers has not been subjected to a compressive force in a specific direction and thus the fiber aggregate is never sprung back, for example, even after formation of the fiber aggregate to thereby attain the fibrous structural article having an excellent shape retentivity; and a production method capable of obtaining such a fibrous structural article using a simple apparatus and in a simple operation.

2. Related Art

Conventionally, a fibrous structural article in a sheet shape or the like has been used for the purpose of heat insulation, sound insulation, shock absorption, and the like in wide fields of products ranging from an interior material for automobile such as a floor trim, a roof trim, and a door trim, to a construction material such as a floor, a ceiling, a wall, and a carpet, of architectural structures including houses, buildings, and the like. It has been frequent to adopt a nonwoven fabric as such a fibrous structural article, and those nonwoven fabrics have been used which were manufactured by various methods such as needle punching, spunbonding, and melt blowing. For example, in Japanese Examined Utility Model Registration Application Publication No. 3147964 and Japanese Unexamined Patent Application Publication No. 2008-89620 a fiber-made substrate (fibrous structural article) is disclosed, which is a fibrous structural article including nonelastic crimped monofilaments and thermally adhesive composite monofilaments mutually mixed at a predetermined weight ratio, wherein affixed points, where the monofilaments are mutually and thermally fusion bonded, are interspersed, and wherein the respective monofilaments are arranged in a direction of a thickness of the fibrous structural article, and which is used as a heat insulator in a ceiling, wall, and the like of a house, in an interior material of an automobile, and the like.

### SUMMARY OF THE INVENTION

The above fiber-made substrate described in Japanese Examined Utility Model Registration Application Publication No. 3147964 and Japanese Unexamined Patent Application Publication No. 2008-89620 is manufactured by a method configured to: once mix the respective monofilaments; spin it out as a uniform web, by a roller card; and subsequently heat-treating the web while folding it into an accordion shape, thereby forming affixed points of the web by thermal fusion bonding (see FIG. 15). This causes such a problem that the accordion web is easily stretched in an inter-layer direction thereof upon application of a pulling force in this direction (see FIG. 16), and the web is occasionally broken at a location between layers (see FIG. 17), so that the web is difficult to handle. Further, the web folded in the accordion shape is subjected to a compressive force in the folded direction upon heatingly and pressurizingly forming the web, thereby bringing about another problem that the formed web is sprung back after removal of pressure (see FIG. 18) such that the web is made unstable in shape.

The present invention has been made in light of the above-mentioned situation. An object of the invention is to provide a fibrous structural article that includes depositedly stacked fibers which are oriented from one surface side toward the other surface side of the fibrous structural article and are arranged in an annual ring centering on a virtual axis, such that the fibrous structural article is rarely stretched and broken even upon application of a pulling force thereto in its radial direction to thereby facilitate its handling, and such that a fiber aggregate comprising the depositedly stacked fibers has not been subjected to a compressive force in a specific direction and thus the fiber aggregate is never sprung back, for example, even after formation of the fiber aggregate to thereby attain the fibrous structural article having an excellent shape retentivity; and a production method capable of obtaining such a fibrous structural article using a simple apparatus and in a simple operation.

The present invention is as follows.

1. A fibrous structural article in a plate-like shape and having multiple fibers adhered to one another, wherein the fibers are oriented from one surface side toward the other surface side of the fibrous structural article, and wherein the fibers are arranged in an annual ring centering on a virtual axis.
2. The fibrous structural article according to 1 above, wherein the fibrous structural article comprises a deep drawn portion which is deep drawn, and a dense portion and a coarse portion in a radial direction of the annual ring, and wherein the dense portion is formed to correspond to the deep drawn portion.
3. The fibrous structural article according to 1 or 2 above, which is obtained by blowing and supplying first short fibers and second short fibers, into a forming mold in a hollow box shape and having a first bottom wall, sidewalls, and second bottom wall, from a fiber supplying port formed through the first bottom wall, and melting at least part of the second short fibers.
4. A production method of a fibrous structural article, comprising: a fiber supplying process for blowing and supplying first short fibers and second short fibers, into a forming mold in a hollow box shape and having a first bottom wall, sidewalls, and second bottom wall, from a fiber supplying port formed through the first bottom wall; and a melting process for melting at least part of the second short fibers.
5. The production method of a fibrous structural article according to 4 above, wherein at least one of the first short fibers and the second short fibers are supplied at a supplying rate adjusted into multiple stages in the fiber supplying process.
6. The production method of a fibrous structural article according to 4 above, wherein the fibrous structural article is configured so that at least one of the first short fibers and the second short fibers are arranged in an annual ring centering on a virtual axis.
7. The production method of a fibrous structural article according to 6 above, wherein at least one of the first short fibers and the second short fibers are supplied at a supplying rate adjusted into multiple stages in the fiber supplying process.

In the fibrous structural article of the present invention, since the multiple fibers constituting the fibrous structural article are oriented from one surface side toward the other surface side of the fibrous structural article, and the fibers are arranged in an annual ring centering on a virtual axis, the fibrous structural article is rarely stretched and broken even upon application of a pulling force thereto in its radial direction, and is rarely sprung back even after formation thereof. Thus, the fibrous structural article is easy to handle, and its predetermined shape is sufficiently kept.

In the case where the fibrous structural article comprises a deep drawn portion which is deep drawn, and a dense portion and a coarse portion in a radial direction of the annual ring, and the dense portion is formed to correspond to the deep drawn portion, it is enabled to sufficiently prevent the deep drawn portion from being formed into a thin layer, thereby making the fibrous structural article to be more homogeneous over the whole area thereof.

In the production method of a fibrous structural article of the present invention, since respective fibers are blown and supplied into a forming mold in a hollow box shape from a fiber supplying port, and then at least part of one of the fibers are melted, a fibrous structural article can be readily manufactured in a simple operation using a simple apparatus, which is easier to handle and has a predetermined shape of which is sufficiently kept.

In the case where at least one of the first short fibers and the second short fibers are arranged in an annual ring centering on a virtual axis, since the stacked first and second short fibers which are supplied about the fiber supplying port are arranged in an annual ring configuration, a fibrous structural article can be readily manufactured which is easier to handle and which keeps a predetermined shape more sufficiently.

Moreover, in the case where at least one of the first short fibers and the second short fibers are supplied at a supplying rate adjusted into multiple stages in the fiber supplying process, the fibers arranged in the annual ring configuration can be readily made to be dense and coarse in the radial direction, such that a predetermined site can be densely formed and another predetermined site can be coarsely formed in consideration of deep drawing and the like, thereby enabling to manufacture a fibrous structural article which is more homogeneous over the whole area thereof.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a schematic view of a forming mold for explaining a situation where respective short fibers are blown into the forming mold through a fiber supplying port formed at a central portion of one bottom wall of the forming mold, so that the fibers are sequentially and depositedly stacked in an annual ring configuration from the inner wall surface of the forming mold to the fiber supplying port at the central portion;

FIG. 2 is a perspective view of a pre-molded body which is formed by depositingly stacking the respective short fibers in the annual ring configuration over the whole of the forming mold from the inner wall surface to the fiber supplying port;

FIG. 3 is a schematic perspective view showing an example of a fibrous structural article which is obtained by heating and pressurizing the pre-molded body in FIG. 2 into a predetermined shape;

FIG. 4 is a perspective view of a pre-molded body containing granular foams interspersed in depositedly stacked short fibers by blowing the granular foams together with the respective short fibers;

FIG. 5 is a schematic perspective view showing an example of a fibrous structural article which is obtained by heating and pressurizing the pre-molded body containing the granular foams interspersed in the depositedly stacked short fibers in FIG. 4 into a predetermined shape;

FIG. 6 is a schematic view of a forming mold for explaining a situation where respective short fibers are blown into the forming mold through two fiber supplying ports formed at one bottom wall of the forming mold, so that the fibers are sequentially and depositedly stacked in annual ring configurations from the inner wall surface of the forming mold and an intermediate portion of the two fiber supplying ports to the two fiber supplying ports;

FIG. 7 is a perspective view of a pre-molded body made of two fiber aggregates in annual ring configurations, respectively, which are formed of the respective short fibers depositedly stacked in the annual ring configurations from the inner wall surface of the forming mold and the intermediate portion of the two fiber supplying ports to the respective fiber supplying ports;

FIG. 8 is a schematic perspective view showing an example of a fibrous structural article which is obtained by heating and pressurizing the pre-molded body in FIG. 7 into a predetermined shape;

FIG. 9 is a schematic view of a fibrous structural article for explaining a situation where the fibrous structural article is rarely stretched even when the same is pulled in a direction of right and left arrows in the figure, because the short fibers depositedly stacked in the annual ring configuration are adhered to one another by thermal fusion bonding;

FIG. 10 is a schematic view of a fibrous structural article for explaining that the fibrous structural article is free of breakage, except for a slight residual deformation in a slightly warped state, upon removal of pressure after application of the pulling force as shown in FIG. 9;

FIG. 11 is a schematic view of a fiber aggregate constituting a pre-molded body to be formed into a fibrous structural article having a deep drawn portion as shown in FIG. 12, in a manner to show a situation that those fibers at a location corresponding to the deep drawn portion are made denser than fibers in the remaining portion;

FIG. 12 is a schematic cross-sectional view of a fibrous structural article for explaining a deep drawn portion when the fibrous structural article is a floor construction material to be laid on a floor panel of an automobile;

FIG. 13 is a schematic view of a pre-molded body for explaining a situation where multiple pre-molded portions are previously formed in the pre-molded body;

FIG. 14 is a schematic view of a molded body for explaining a situation where the pre-molded body of FIG. 13 is established into the molded body formed with multiple fiber-molded portions;

FIG. 15 is a schematic view of a conventional fiber-made substrate viewed from an oblique direction, which is manufactured by using a web formed of stacked fibers and by folding it;

FIG. 16 is a schematic view for explaining that the conventional fiber-made substrate of FIG. 15 is easily stretched when the same is pulled in a folded direction of the web;

FIG. 17 is a schematic view for explaining a situation that the conventional fiber-made substrate of FIG. 15 is easily broken along a folded crease even when the fiber-made substrate is intended to be deformed in its thickness direction; and

FIG. 18 is a schematic view for explaining a situation that the conventional fiber-made substrate to be formed in a state compressed in the folded direction is sprung back after removal of pressure.

### DETAILED DESCRIPTION OF THE INVENTION

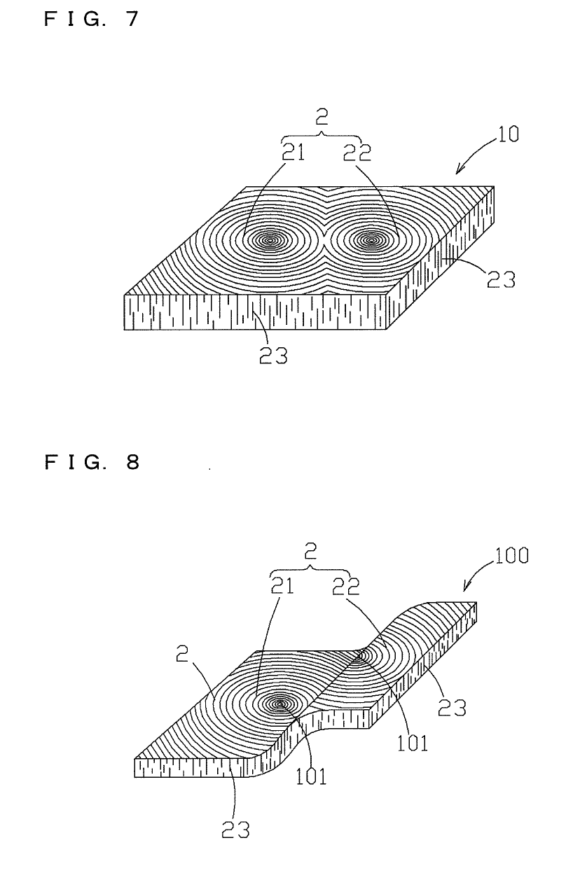

Hereinafter, the present invention is described in detail using FIGS. 1 to 14. The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

### (1) Fibrous Structural Article

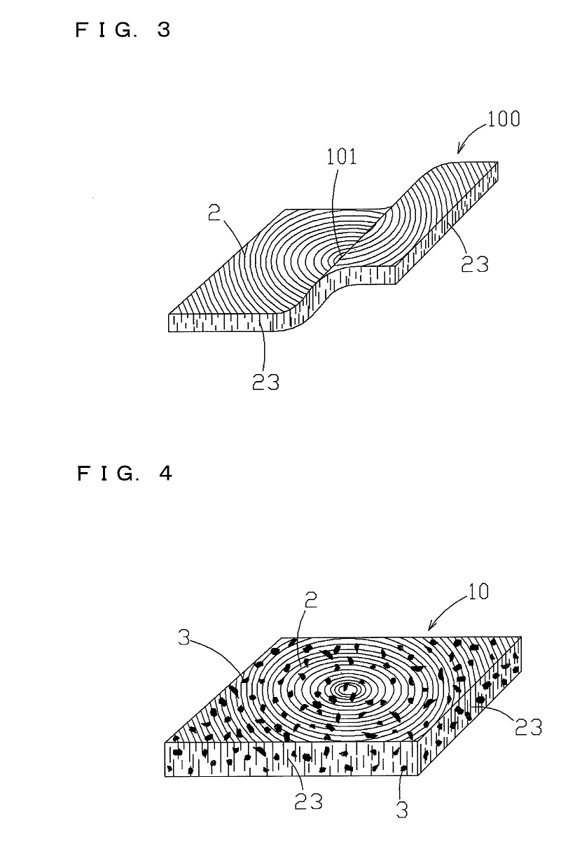

The fibrous structural article as an embodiment of the present invention is a fibrous structural article 100 in a plate-like shape and having multiple fibers 23 which are adhered to one another, and the fibers 23 are oriented from one surface side toward the other surface side of the fibrous structural article, and the fibers 23 are arranged in an annual ring centering on a virtual axis 101 (see FIGS. 3, 5, and 8).

The fibers 23 in the fibrous structural article 100 of the present invention are oriented in a vertical direction or oblique direction from an upper surface side toward a lower surface side of the fibrous structural article in FIG. 3, for example. The fibrous structural article of the present invention may further include fibers oriented in a lateral direction.

The “fiber” is not particularly limited and example thereof includes various synthetic fibers, and a natural fiber made from jute or cotton. The fiber is preferably one of synthetic fiber. Examples of the synthetic fiber include a polyester fiber such as a polyethylene terephthalate fiber and polybutylene terephthalate fiber; a polyamide fiber such as nylon 6 fiber and nylon 66 fiber; a polyolefin fiber such as polyethylene fiber and polypropylene fiber; an acrylic fiber such as poly methyl methacrylate fiber; and the like. The synthetic fiber is preferably a polyester fiber and polyolefin fiber. The type of fibers may be single or in combination of two or more.

The multiple fibers constituting the fibrous structural article are adhered to one another at least portions of them in the longitudinal directions thereof. To obtain such a fibrous structural article where fibers are adhered to one another and the fibrous structural article has a sufficient tensile strength and the like, a substance-oriented fiber and a binder-oriented fiber are typically adopted, where the latter are melted at a temperature lower than that at which the substance-oriented fiber is melted. The substance-oriented fiber and binder-oriented fiber are adhered by virtue of the binder-oriented fibers, and the binder-oriented fibers themselves are adhered to each other therebetween, thereby forming a fibrous structural article. This adhesion among the fibers may be attained by adopting a liquid adhesive such as a urethane-based adhesive.

The binder-oriented fiber is preferably a low melting-point polyester fiber, polyolefin fiber and the like, which are melted at lower temperature to adhere the substance-oriented fibers. As the binder-oriented fiber, a sheath-core fiber can be used having a low melting-point sheath portion, and a high melting-point core portion, which is not melted at a temperature, at which the sheath portion is melted. Examples of the sheath-core fiber include: a sheath-core fiber consisting of a sheath portion having a relatively low melting-point polyester, and a core portion having a relatively high melting-point polyester; a sheath-core fiber having a sheath portion consisting of a polyethylene, and a core portion consisting of a polypropylene; and the like. It is further possible to adopt a side-by-side fiber such as one containing a polypropylene and polyethylene, as the binder-oriented fiber.

The weight ratio of the fiber for binding is not particularly limited and is preferably in the range from 5% to 50% by weight, and particularly from 15% to 25% by weight, assuming that the total amount of the fibers for a base and fibers for binding is 100% by weight. When the weight ratio of the fibers for binding is in the range from 5% to 50% by weight, a fibrous structural article can be efficiently obtained which has a predetermined tensile strength, and the like.

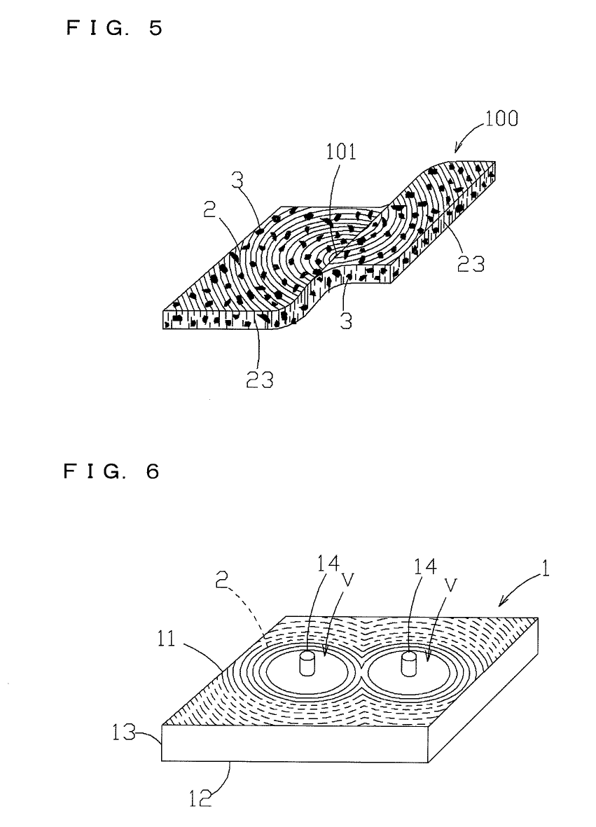

The fibrous structural article may contain a granular foam consisting of a resin such as a polyurethane and a polyolefin therein. (see a pre-molded body 10 in FIG. 4, and the fibrous structural article 100 in FIG. 5). The foam may be unused one, and it is also possible to utilize a waste material insofar as capable of obtaining a fibrous structural article in a predetermined quality. For example, it is possible to reuse: crushed matters contained in the remainder of a shredder dust of an automobile after removal therefrom of metal, glass, wire harness, and the like; and chips to be brought about by trimming an interior material such as a floor trim, roof trim and door trim of an automobile upon manufacturing the interior material; and the like.

The shape of the granular foam is not particularly limited. For example, crushed matters and chips are unshaped. The dimension of the granular foam is not particularly limited and a granular foam having maximum dimension of 5 to 18 mm, and particularly 10 to 15 mm may be used. The maximum dimension of the granular foam is to be preferably selected, depending on the thickness of fibrous structural article. The weight ratio between the fiber and the granular foam is not particularly limited, insofar as the granular foam can be adhered to the fibers by the binder-oriented fibers such that the granular foams are not easily separated from the fibers. The foams may be included in an amount of 7.5% to 65% by weight, and particularly 10% to 60% by weight assuming that the total amount of the fibers and the foams is 100% by weight. (The preferable weight ratio between the substance-oriented fibers and the binder-oriented fibers in the fibers, is described above.) In the case where the fibers and the granular foams can be sufficiently uniformly dispersed even when the fibers are used in a smaller amount, it is possible to adhere the foams to the fibers such that the granular foams are not easily separated therefrom.

In the fibrous structural article 100 of the present invention, fibers are arranged in an annual ring centering on a virtual axis 101 (see FIGS. 3, 5, and 8). The “virtual axis 101” implies a central axis of a fiber supplying port 14 (see FIGS. 1 and 6) through which fibers are supplied while blowing upon manufacturing of the fibrous structural article 100 as will be described later concerning the production method of a fibrous structural article (2), such that the fibers are supplied in a direction from the central axis toward a circumference and sequentially and depositedly stacked in a concentric configuration from inner sidewall face 13 of the forming mold 1 toward the central axis of the fiber supplying port 14, so that the fibers are arranged substantially in an annual ring configuration as described above. The virtual axis 101 may be provided singly (see FIGS. 3 and 5), or plurally (see FIG. 8 where two virtual axes are provided).

The fibrous structural article may contain various additives, as required. Example thereof includes an antioxidant, a ultraviolet absorber, a lubricant, a flame retardant, a auxiliary flame retardant, a softener, an inorganic or organic filler for improving the impact resistance, heat resistance or the like of the fibrous structural article, a antistatic agent, a coloring agent, a plasticizer, and the like. Each additive can be contained in the fibrous structural article, by previously blending the additive into substance-oriented fibers and/or binder-oriented fibers. In the case where granular foams are used, each additive may be one, which is contained in the foams.

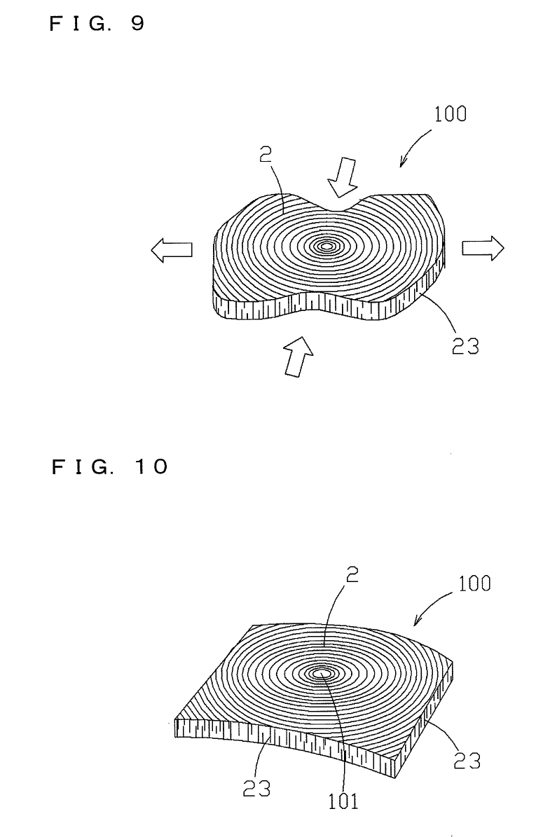

In the fibrous structural article 100 of the present invention, the fibers 23 are oriented from one surface side toward the other surface side of the fibrous structural article, and the fibers are arranged in an annual ring centering on a virtual axis 101 (see FIGS. 3, 5, and 8). Therefore, the fibrous structural article is rarely deformed and is never easily broken, even upon application of a pulling force thereto in a plane direction. For example, when the fibrous structural article 100 is subjected to application of a pulling force in a certain plane direction as shown in FIG. 9, the fibrous structural article is brought into a state compressed in the other perpendicular direction to thereby react against the pulling force in a manner to disperse the pulling force, so that the fibrous structural article is rarely stretched in the applied direction of the pulling force and is thus never easily broken. Further, although the fibrous structural article 100 is subjected to a slight residual deformation in a slightly warped state after release of the pulling force as shown in FIG. 10, the fibrous structural article is never deformed considerably nor broken.

### (2) Production Method of Fibrous Structural Article

The production method of a fibrous structural article 100 as an embodiment of the present invention comprises a fiber supplying process and a melting process. In the fiber supplying process, first short fibers 23 and second short fibers 23 are supplied while blowing into a forming mold 1 in a hollow box shape and having a first bottom wall 11, sidewalls 13, and second bottom wall 12, from a fiber supplying port 14 which is formed through the first bottom wall 11. In the melting process, at least part of the second short fibers 23 is molten to bind first short fibers 23 (see FIGS. 1 to 3; where the first short fibers and second short fibers are designated by the same reference numerals, respectively, because they are not particularly required to be distinguished from each other in these figures).

In the fiber supplying process, the first and second short fibers 23 are blown and supplied into the forming mold 1. In the case of producing a fibrous structural article 100 containing granular foams 3 shown in FIG. 5, the granular foams 3 are blown and supplied together with the first and second short fibers 23. The explanation for the granular foams described in the fibrous structural article (1) above is applied to the granular foams 3. It is noted that the same reference numeral is assigned to the granular foams in FIGS. 4 and 5 as expediency. In FIG. 5, the same reference numeral is assigned to a fibrous structural article containing no granular foams and a fibrous structural article containing granular foams, as expediency. Moreover, although the first bottom walls 11 are shown as ones at upper sides, respectively, and the first and second short fibers 23 and the like are blown and supplied from the above in FIGS. 1 and 6, it is also possible to arrange the first bottom walls 11 as ones at lower sides, respectively, and to blow and supply first and second short fibers 23 and the like from the below.

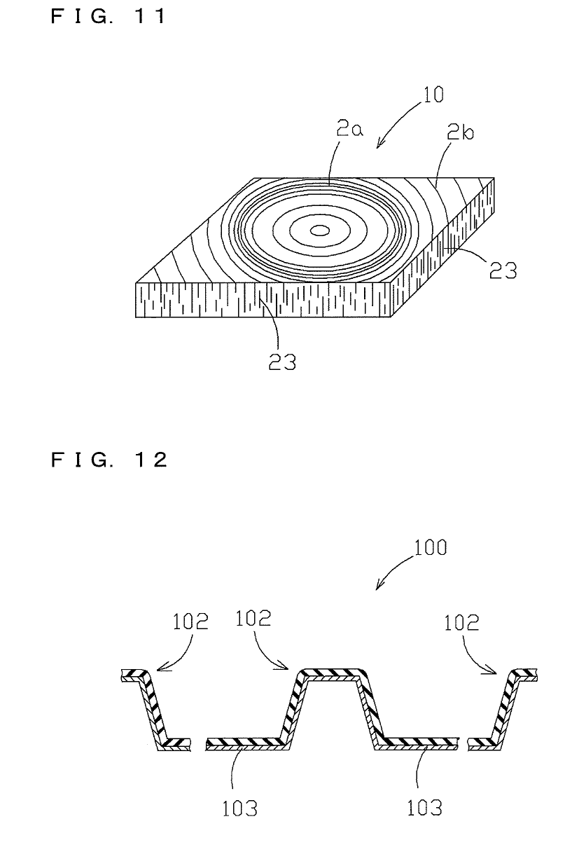

The supplying rates of the first and second short fibers and the like into the forming mold may be constant, or adjusted to be changed to multiple stages. Changing of the supplying rate by multiple stages leads to a formation of clearer boundary portions in the radial direction of the fiber aggregate comprising the fibers arranged in an annual ring configuration. When a fibrous structural article 100 having a deep drawn portion 102, for example, shown in FIG. 12 is produced, a pre-molded body 10 shown in FIG. 11, in which the dense portion 2a corresponds to the portion 102 to be deep drawn may be used which is fabricated by increasing a supplying rate of the first and second short fibers 23 and the like to form a radially dense portion 2a, and decreasing the supplying rate of them to form a radially coarse portion 2b. In this way, it is enabled to prevent a damage of the pre-molded body 10 upon deep drawing, and also to prevent the deep drawn portion 102 from being formed into a thin layer.

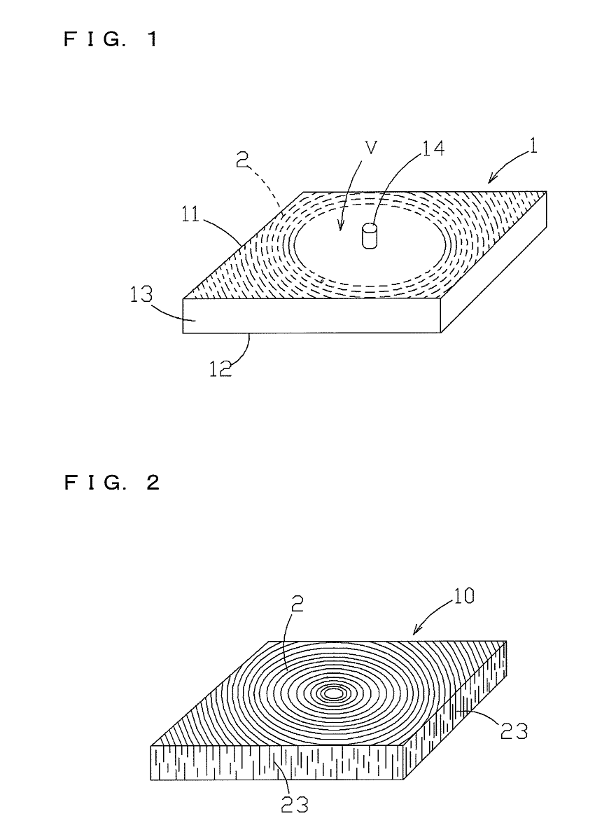

The “forming molds 1” is in a hollow box shape, and has the first bottom wall 11, sidewalls 13, and second bottom wall 12 (see FIGS. 1 and 6). The forming mold 1 has an interior space whose shape is substantially the same as the contour of the pre-molded body 10 (see FIGS. 2, 4, and 7) for manufacturing plate-like fibrous structural article 100 (see FIGS. 3, 5, and 8), and the space is typically in flat-plate shape thicker than the fibrous structural article 100. In addition, the material of the forming mold 1 is not particularly limited and is to be preferably made of metal, in consideration of processability, heat resistance, and the like. The type of the metal is not particularly limited as well, and it is possible to adopt a stainless steel, aluminum, and the like. The forming mold 1 can be made to have a sufficient strength and to be rarely rusted when the same is made of stainless steel, while the forming mold 1 can be made to have a sufficient strength and to be light-weighted when the same is made of aluminum.

The “fiber supplying port 14” is arranged at the “first bottom wall 11” of the bottom walls of the forming mold 1 to blow and supply the first and second short fibers 23 (the granular foams 3 may be simultaneously blown and supplied) into the forming mold 1. When the first and second short fibers 23 are supplied, a fiber aggregate 2 comprising the first and second short fibers arranged in an annual ring centering on a virtual axis 101 (see FIG. 1). It is noted that the same reference numeral is assigned to the fiber aggregate in the pre-molded body 10 of FIG. 2 and to the fiber aggregate in the fibrous structural article 100 of FIG. 3, as expediency.

As described in the fibrous structural article (1) above, the virtual axis may be provided singly (see FIGS. 3 and 5), or plurally (see FIG. 8 where two virtual axes are provided). Namely, the fiber supplying port 14 may be provided singly (see FIG. 1), or plurally (see FIG. 6 where two fiber supplying ports are provided). For example, the two virtual axes 101 of the fibrous structural article 100 as shown in FIG. 8 imply central axes of the two fiber supplying ports 14, respectively, through which fibers are to be blown and supplied upon manufacturing of the fibrous structural article 100 as described in the fibrous structural article (1) above, such that the fibers are supplied from these central axes in directions from the central axes toward a circumference and sequentially and depositedly stacked in concentric configurations from the inner wall surface 13 of the forming mold 1 and from a collision face between fibers supplied from the fiber supplying ports 14, toward the central axes, thereby forming two fiber aggregates 21, 22 substantially in annual ring configurations, respectively.

The mold wall of the forming mold 1 is configured to have an air permeability. While the mold wall is allowed to have an air permeability by fabricating the forming mold 1 from an appropriate type of material having an air permeability in itself, it is also possible to achieve a mold wall having an air permeability even when the forming mold 1 is made of metal, by forming multiple apertures through the mold wall. The shape of the aperture is not particularly limited, and may be circular, elliptical, polygonal such as triangle and rectangle, star-shaped, or the like.

Further, the aperture is allowed to have a maximum spread (i.e., a maximum diameter when the aperture is in circular, or a maximum dimension when the aperture is in other shapes) in the range from 1 mm to 10 mm, and particularly from 1 mm to 6 mm, depending on fiber lengths of the first and second short fibers 23 to be blown and supplied from the fiber supplying port(s) 14. Furthermore, the apertures are to be preferably provided over the whole area of the mold wall of the forming mold 1 in a substantially uniform manner, thereby enabling to manufacture a fibrous structural article 100, which is more homogeneous in a plane direction. Moreover, it is more preferable that the apertures are substantially equispacedly provided over the whole area of the mold wall of the forming mold 1.

In FIGS. 1 and 6, the planar shape of the forming mold 1 is rectangular. The shape is not limited to this and may be polygonal such as square and triangle, and circular, elliptical, or the like. The shape of the forming mold 1 may be one where four corners of a rectangle are cut out, such as in case of manufacturing a fibrous molded article 100b for fibrous structural article shown in FIG. 14.

In the case of a forming mold having a circular shape in plan view, when the first and second short fibers and the like are blown and supplied into the forming mold through one fiber supplying port formed at a central portion of the forming mold, it is possible to readily manufacture a fibrous structural article comprising fibers arranged in an annual ring configuration over the whole of the fibrous structural article. Additionally, in the case of a forming mold having a shape in plan view where four corners of a rectangle are cut out, it is also possible to facilitate to arrange the fibers in an annual ring configuration over the whole of a fibrous structural article, in the same manner as the above. Moreover, in the case of a forming mold having an elliptical shape in plan view, when the first and second short fibers and the like are blown and supplied into the forming mold through two fiber supplying ports formed in a major axis direction of the ellipse while distances between the two fiber supplying ports and the associated inner wall surfaces, respectively, and the distance between the two fiber supplying ports themselves are substantially equalized, it is possible to readily manufacture a fibrous structural article having two fiber aggregates each comprising fibers arranged in an annual ring configuration.

The “first short fiber” is a fiber acting as the substance-oriented fiber as described in the fibrous structural article (1) above, and the “second short fiber” is a fiber acting as the binder-oriented fiber as described in the fibrous structural article (1) above. Examples of the first and second short fibers include the various natural fibers and synthetic fibers as described above. The synthetic fibers are preferable among them, and polyester fibers and polyolefin fibers are particularly preferred. Further, the preferable fiber as the second short fiber intended to act as the binder-oriented fiber is a low melting-point polyester fiber, polyolefin fiber, and the like, which are melted at lower temperatures and readily adhered to the first short fiber intended to act as the substance-oriented fibers as described above. It is also possible to use the above-described sheath-core fibers and side-by-side fibers.

Although both the first short fibers and second short fibers are not particularly limited in fineness and fiber length. The average fineness is preferably in the range from 1 to 10 dtex, and particularly from 3 to 6 dtex. The average fiber length is preferably in the range from 5 to 20 mm, and particularly from 7 to 13 mm. The average fiber lengths of the first and second short fibers are average values, each obtained by randomly extracting a single fiber one by one and straightly extending it without stretching it, and by measuring the fiber length on a placed ruler, for a total of 200 fibers, by a direct method according to JIS L1015.

In the “melting process”, at least part of the second short fibers is melted. The first short fibers are not melted at all in this melting process. The first short fibers and the second short fibers, at least part of which are melted, are adhered to each other therebetween, and the second short fibers themselves are adhered to each other therebetween, followed by formation of a fibrous structural article by cooling them. The heating temperature is set at which the second short fibers are melted, at a predetermined temperature where the first short fibers are not melted at all and at least part of only the second short fibers are melted to thereby act as the binder-oriented fibers, in consideration of materials, melting points, and the like of the first and second short fibers. The heating time is not particularly limited depending on materials of the first and second short fibers and the heating temperature. It is not preferable to heat them to such an extent that substantially the whole of the second short fibers is melted to lose fibrous shapes, and it is preferable to conduct the heating for a period of time as short as possible insofar as the first short fibers and second short fibers are sufficiently adhered to one another therebetween.

In the melting process, when at least part of the second short fibers 23 are melted and the first short fibers 23 and the second short fibers 23 and the like are adhered to one another therebetween, the fibrous structural article 100 is manufactured. The fibrous structural article 100 can be manufactured, for example, by heating a pre-molded body 10 formed in the associated forming mold 1 (see FIGS. 2, 4, and 7) to a predetermined temperature to be set in consideration of the melting points of the first and second short fibers 23, and pressurizing the pre-molded body as required. More specifically, the fibrous structural article 100 can be manufactured by such a method configured to: heat the pre-molded body 10 by passing it through a heating furnace, or by heating it with a far infrared heater, for example, to thereby soften and melt the second short fibers 23; and subsequently pass the heated body between a pair of cooling rolls, or press and cool it between cooling press plates.

The fibrous structural article manufactured in the above manner is in a flat-plate shape and is directly utilizable depending on its usage or the like, however, it is frequent to form and use a fibrous structural article in a predetermined shape with a forming mold, in a manner that the fibrous structural article is formed to be disposed between: a surface (back surface) of an interior material such as a floor trim, a roof trim and a door trim of an automobile, reverse to a designed surface of the interior material; and an automobile body panel; such that the fibrous structural article follows the shape of the interior material or automobile body panel. It is not always necessary for the fibrous structural article to be accurately formed into a predetermined shape, and it is enough for it to be in a shape substantially following a shape of an interior material or automobile body panel. The method for additionally molding such a pre-molded body in an original flat-plate shape is not particularly limited, and it is possible to manufacture a fibrous structural article in a predetermined shape by pressurizing a pre-molded body in an original flat-plate shape previously heated to a predetermined temperature, by means of a forming mold at an ambient temperature or previously cooled to a predetermined temperature as required. Further, it is also possible to adopt a forming mold and to place a pre-molded body in an original flat-plate shape in the forming mold controlled to a predetermined temperature to thereby heat and pressurize the pre-molded body, followed by cooling, to manufacture a fibrous structural article in a predetermined shape.

The first and second short fibers 23 blown and supplied into the forming mold 1 in the fiber supplying process (granular foams 3 are simultaneously blown and supplied, as the case may be) are heated typically in a state filled in the forming mold 1, thereby forming the pre-molded body 10. Part of the second short fibers 23 are softened and melted by the heating at this time, and parts of the first short fibers 23 and second short fibers 23 are adhered to one another, to form the applicable pre-molded body 10 (see FIGS. 2, 4, and 7).

The heating temperature and heating time upon formation of the pre-molded body are not particularly limited and may be appropriately set, insofar as the pre-molded body is sufficiently kept in shape and readily handled when it is subjected to the melting process. Further, the heating method is not particularly limited and may be exemplarily configured to leave a forming mold filled with the first and second short fibers and the like to stand still in a heating furnace, or to pass the forming mold through a heating furnace, and it is also possible to conduct heating by blowing a hot air into a forming mold through apertures formed therethrough.

### (3) Usage of Fibrous Structural Article

The fibrous structural article of the present invention is not particularly limited and is usable in wide product fields ranging from materials for automobile to construction materials. And it is particularly useful as an interior material for an automobile. For example, the fibrous structural article is subjected to forming to be disposed between: a surface (back surface) of an interior material such as a floor trim, roof trim and door trim, reverse to a designed surface of the interior material; and an automobile body panel; such that the fibrous structural article follows the shape of the interior material or automobile body panel. The fibrous structural article of the present invention is rarely deformed and is never easily broken, so that it is useful as a large-size member disposed between an interior material and an automobile body panel.

Since the fibrous structural article is used in various usages, the thickness thereof is not particularly limited and may be appropriately selected depending on the usage or the like. The fibrous structural article is allowed to have a thickness of usually 5 to 200 mm, and particularly 5 to 80 mm. Even if the thicknesses of the fibrous structural article is in the range from 5 to 200 mm, sufficient strength and the like are obtained in many usages and the fibrous structural article can be used as a light-weight member.

### EXAMPLE

Hereinafter, the invention will be more specifically described by way of Examples.

### Example 1

Used were: 40% by weight of polyethylene terephthalate fibers having an average fineness of 3.3 dtex and an average fiber length of 10 mm (trade name “SD150” manufactured by Takayasu Co., Ltd.) as the first short fiber; 40% by weight of thermally fusion-bondable sheath-core type fibers having an average fineness of 2.2 dtex and an average fiber length of 10 mm (trade name “T9611” manufactured by Toray Industries Inc.) as the second short fibers, respectively, each comprising a material at a core portion made of a polyethylene terephthalate having a melting point of 260° C., and a material at a sheath portion made of a copolymerized polyester having a melting point of 110° C.; and 20% by weight of a granular polyurethane foam having a density of 0.015 to 0.030 g/cm3 and a maximum dimension of 15 mm, that was a crushed matter obtained by crushing a massive soft polyurethane foam.

The first and second short fibers and the granular polyurethane foams were dry blended, and the mixture was fed by air into a forming mold 1 made of stainless steel in a shape shown in FIG. 1, firstly at a rate of 50 g/sec for 30 seconds, then at a rate of 40 g/sec for 15 seconds, and further at a rate of 20 g/sec for 15 seconds, in a total amount of 2,400 g. The mold had inner dimensions of 900 mm length, 900 mm width, and 100 mm thickness, and was formed with circular apertures through mold walls. Thereafter, hot air was blown into the forming mold from the apertures formed through the mold walls to soften and melt part of the second short fibers to thereby adhere the first short fibers and second short fibers and the like to one another therebetween, thereby forming a pre-molded body 10 as shown in FIG. 11 where the pre-molded body was formed with a radially dense portion 2a and a radially coarse portion 2b, and where the fibers 23 were arranged in an annual ring configuration. This pre-molded body 10 had substantially the same dimensions as the inner dimensions of the forming mold.

The thus formed pre-molded body 10 was heated at a temperature of 180° C. for 30 seconds, and then the pre-molded body 10 was placed in another forming mold having a cavity in a predetermined shape and pressurized at a pressure of 100 Mpa for 0.5 to 1 second at a room temperature (25° C. to 30° C.). Subsequently the resultant molded body was cooled by flowing water at the room temperature through flow passages for cooling medium in the mold, thereby manufacturing an automobile floor construction material (fibrous structural article 100) to be laid on a floor panel of an automobile and having a deep drawn portion 102 following a shape of the floor panel, as shown in FIG. 12. It is noted that when the supplying rates of the first and second short fibers and the like are adjusted, a pre-molded body 10 can be obtained in which the fibers 23 arranged in the annual ring configuration are allowed to be established into the dense portion 2a and coarse portion 2b as shown in FIG. 11. Further, in the case of such a pre-molded body, when an automobile floor construction material (fibrous structural article 100) having the deep drawn portion 102 as shown in FIG. 12 is manufactured, it is enabled to prevent a damage of the pre-molded body upon formation thereof and to sufficiently prevent the deep drawn portion 102 from being formed into a thin layer, by deep drawing the pre-molded body such that the dense portion 2a which is apt to be stretched corresponds to the deep drawn portion 102.

### Example 2

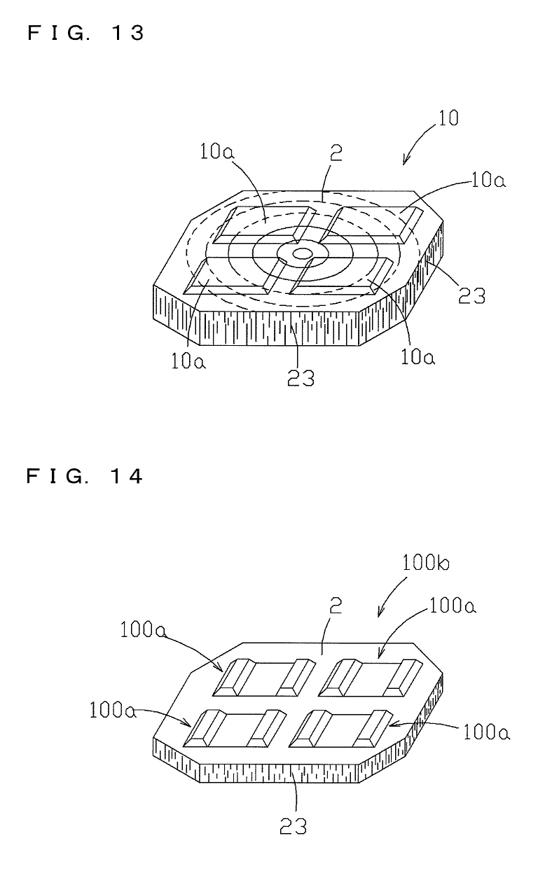

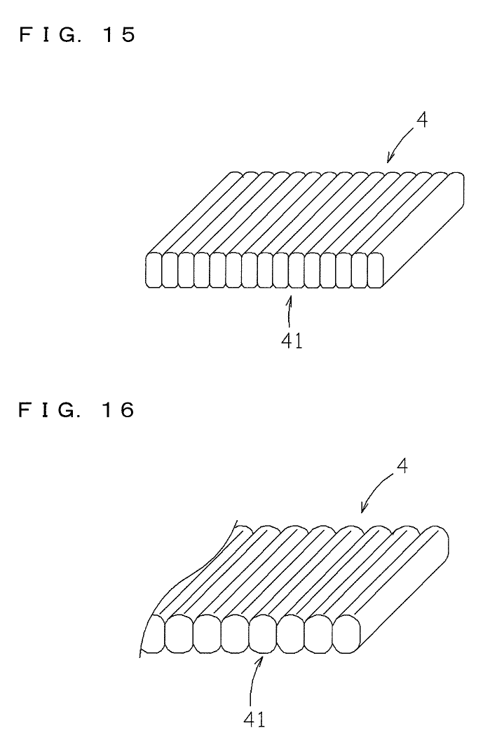

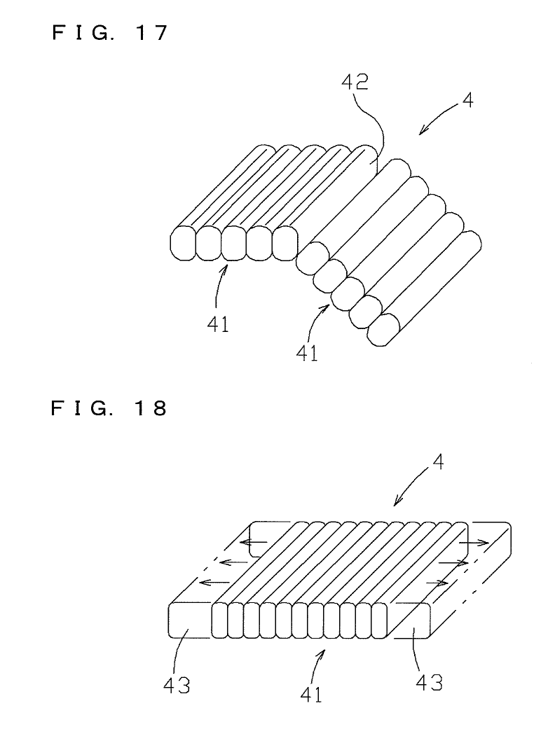

20% by weight of first short fibers, 20% by weight of second short fibers, and 60% by weight of granular polyurethane foams were dry blended to obtain a mixture, which was fed by air and supplied at a constant rate of 50 g/sec into a forming mold having a mold face following shapes of portions 10a to be pre-molded, thereby forming a pre-molded body 10 having four pre-molded portions 10a as shown in FIG. 13. Thereafter, the pre-molded body 10 having the formed four pre-molded portions 10a was subjected to heating in the same manner as that in Example 1 to manufacture a fibrous molded article 100b for fibrous structural article having the four molded fiber-made portions 100a as shown in FIG. 14. (It is noted that broken lines in an annual ring configuration are omitted in FIG. 14, so as to avoid complication.)

As described above, particularly when each fibrous structural article is to have a more complicated final shape, it is also possible to manufacture the fibrous molded article 100b for fibrous structural article by previously forming the pre-molded portions 10a each in a shape corresponding to the final shape. In this way, it is enabled to obtain a fibrous structural article which is homogeneous without a considerable difference in density between convex portion and concave portion even when the fibrous structural article is in a more complicated shape. Further, particularly in the case of a relatively small-sized fibrous structural article, it is also possible to use a so-called multi-cavity mold in a manner: to simultaneously form molded fiber-made portions 100a to be established into multiple fibrous structural article (in FIG. 14, four molded fiber-made portions 100a are formed); and to subsequently cut out predetermined fibrous structural article from the fibrous molded article 100b for fibrous structural article, into multiple products, as in this Example.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

1. A fibrous structural article in a plate-like shape and having multiple fibers adhered to one another,
wherein said fibers are oriented from one surface side toward the other surface side of said fibrous structural article, and
wherein said fibers are arranged in an annual ring centering on a virtual axis.

2. The fibrous structural article according to claim 1,
wherein said fibrous structural article comprises a deep drawn portion which is deep drawn, and a dense portion and a coarse portion in a radial direction of said annual ring, and
wherein said dense portion is formed to correspond to said deep drawn portion.

3. The fibrous structural article according to claim 1, which is obtained by blowing and supplying first short fibers and second short fibers, into a forming mold in a hollow box shape and having a first bottom wall, sidewalls, and second bottom wall, from a fiber supplying port formed through said first bottom wall, and melting at least part of said second short fibers.

4. A production method of a fibrous structural article, comprising:
a fiber supplying process for blowing and supplying first short fibers and second short fibers, into a forming mold in a hollow box shape and having a first bottom wall, sidewalls, and second bottom wall, from a fiber supplying port formed through said first bottom wall; and
a melting process for melting at least part of said second short fibers.

5. The production method of a fibrous structural article according to claim 4,
wherein at least one of the first short fibers and the second short fibers are supplied at a supplying rate adjusted into multiple stages in the fiber supplying process.

6. The production method of a fibrous structural article according to claim 4,
wherein said fibrous structural article is configured so that at least one of said first short fibers and said second short fibers are arranged in an annual ring centering on a virtual axis.

7. The production method of a fibrous structural article according to claim 6,
wherein at least one of the first short fibers and the second short fibers are supplied at a supplying rate adjusted into multiple stages in the fiber supplying process.

8. The fibrous structural article according to claim 2, which is obtained by blowing and supplying first short fibers and second short fibers, into a forming mold in a hollow box shape and having a first bottom wall, sidewalls, and second bottom wall, from a fiber supplying port formed through said first bottom wall, and melting at least part of said second short fibers.
